(19) United States
(12) Patent Application Publication
(10) Pub. No.: US 2013/0319537 A1
(43) Pub. Date: Dec. 5, 2013

(54) Flow Control of Combustible Mixture into Combustion Chamber

(71) Applicant: Wajid Ali CHISHTY, Orleans (CA)

(72) Inventor: Wajid Ali CHISHTY, Orleans (CA)

(21) Appl. No.: 13/487,522

(22) Filed: Jun. 4, 2012

(51) Int. Cl. F17D 1/16

(52) U.S. Cl. 137/13; 137/803

(57) ABSTRACT

In a premix supply, for supplying a fuel and oxidizer gas into a combustion chamber for burning, the premix supply having a smaller diameter flow than the combustion chamber, the premix supply comprising at least one dielectric barrier discharge device (DBD) comprising two electrodes separated by a dielectric, improved flame stability limits may be provided for the adjacent combustor by the actuation of the DBD to induce ionic wind. Both electrodes may be provided in a single wall of the premix supply. The two electrodes may be arranged substantially upstream and downstream of each other. The electrodes may be arranged to generate an ionic wind preferentially directed in a direction of flow through the premix supply.

### FIELD OF THE INVENTION

The present invention relates in general to fluid control of combustible mixtures of fuel and air from a supply into a combustion chamber, where the combustion chamber presents an enlarged cross-section in comparison with the flow.

### BACKGROUND OF THE INVENTION

Controlled burning of combustible mixture of oxidizer and fuel, like in a gas fueled combustor, or a prevaporized premixed liquid fuel combustor, requires a balance of several conditions concurrently. One balance is between a leaner (relatively higher oxidizer content) and a richer (relatively higher fuel content) mixture. Another is the balance between higher and lower mass flow rates of the mixture. The mass flow rate effectively determines a velocity of the mixture in most operational combustors. Richer mixtures, with lower mixture velocities tend to flashback. Flashback is a dangerous condition where the flame begins to travel back through the supply tube: obviously a condition to be avoided because the required thermal protection to safely contain a flame is only provided in the combustion chamber. Too lean a flame, and too high a mixture velocity tends to result in a blow-out, in which the flame is extinguished. Too high a velocity in a rich gas supply can also lead to flame lift-off, which is another potential problem with flame delocalization. Within these ranges are the operable limits of a combustor, and within the operable limits are the limits for stable combustion. There are many features that affect stable operating limits of flames, that cross over disciplines of chemistry, thermodynamics and fluid dynamics.

Generally, the highest combustion efficiency is provided by the hottest, most concentrated flame, the richest premix (up to stoichiometric balance). It is also desirable for combustors to exhibit various properties, such as: low emissions, high flame stability, and stability under changing conditions such as fluctuations in the fuel supply composition, temperature, moisture content, thermal demand, etc. There are applications for which a leanest safe burning regime is particularly important, and there are applications for which a widest operating range (between coolest and hottest operation) are particularly important.

There are many designs for combustors that are well suited to particular applications, but there are generally only two levers available to control operating conditions of combustors, that allow for the varying combustion conditions. Typically combustors control the supplies of oxidizer gas, and fuel, and therefore their ratio. While various sensors may be applied to detect different operating conditions, the feedback typically only controls a mass flow rate of the oxidizer and the mass flow rate of the fuel gas.

Dielectric Barrier Discharge devices (DBDs), also known as plasma actuators, non-equilibrium plasmas, non-thermal plasmas, or corona discharge devices are actuable devices that have known applications. To date, experimental applications of DBDs have been mainly in the area of flow-control/aerodynamics. For example, an ionic jet that is generated from DBDs has been shown to be effective in controlling the stall of stationary airfoils [5], provoking the stall of wind turbine blades [6], damping the vortex shedding induced oscillations of bluff bodies [7], controlling the boundary layer transitions [8], etc. Typically these are for ambient temperature, ambient pressure flows of non-combustible gasses.

Recently, DBDs have also been applied in chemically reacting flows, to enhance combustion kinetics. In these applications, DBDs improve flame stability and consumption efficiency by cracking the fuel and/or air particles into smaller stable molecules and active radicals, thus assisting in the initiation of chain branching reactions, to better control a supply of reactants for combustion. Such cracking has been provided by DBDs in the fuel supply and/or the oxidizer supply. In some applications, the DBD has been placed in a premix chamber [9]. In these combustion experiments, which were conducted at atmospheric conditions, interactions between the fuel and/or air particle flow and the cold plasma was encouraged by requiring the flow to pass through the plasma region. To this end, the mixing chamber was configured with the DBD covering the complete combustor cross-section, using a high voltage electrode needle inserted axially through, and concentric with, the premix chamber. The electric power necessary to obtain a significant effect on combustion kinetics has been found to be less than 1% of the combustor thermal power. It has also been shown that plasma actuation improves the flame blowout limit and reduces ignition delay time by an order of magnitude. Other chemical kinetics studies show that application of DBD leads to a more complete combustion [10] and helps reducing soot production in diffusion flames [11]. All of these papers focus on improving stability of a flame by extending a blowout limit of the burner.

Accordingly there is a need for improved control over a premix supply when the flow transits from a premix chamber to an enlarged combustion chamber.

### SUMMARY OF THE INVENTION

The advantages of a DBD plasma actuator over other known flow control devices are at least that it has a very small profile (minimum protrusion into the premix supply), simplicity of use and design, robustness (no moving parts), and yet can have significant impact on the flow. In addition the setup needs low-power and low-weight generators for operation.

Accordingly a premix supply is provided for supplying a fuel and oxidizer gas into a combustion chamber for burning, where the premix supply has a smaller diameter flow than the combustion chamber. The premix supply has at least one dielectric barrier discharge device (DBD) comprising two electrodes separated by a dielectric. In accordance with the invention, both electrodes are provided in a single wall of the premix supply, or the electrodes are arranged to generate an ionic wind preferentially directed in a direction of flow through the premix supply, or the electrodes are arranged substantially upstream/downstream of each other.

The at least one DBD may be disposed symmetrically around the premix supply, for example adjacent a dump plane defined by the interface of the premix supply and the combustion chamber. The electrodes may be arranged to accelerate the fuel and oxidizer gas in a direction along the wall. The DBD may provide greater acceleration occurring closer to the wall of the premix supply, whereby a pipe-flow velocity profile of the fuel and oxidizer gas is modified to increase a velocity gradient at the wall. The at least one DBD may include a plurality of DBDs, each which being in a same wall, the wall defining an outer diameter of a flow of the fuel and oxidizer gas.

Also provided is a burner comprising a premix supply in communication with the combustion chamber. Furthermore, a method is provided for reducing flashback within a burner having a premix supply in fluid communication with a combustion chamber where the premix supply has a smaller diameter flow than the combustion chamber. The method involves: providing in a wall of the premix supply at least one dielectric barrier discharge device having two electrodes separated by a dielectric; and applying current to the dielectric barrier discharge device to generate an ionic wind preferentially in a same direction as a flow through the premix supply, at least when there is an elevated risk of flashback along the wall.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a schematic illustration of a dielectric barrier discharge (DBD), showing an induced plasma, and ionic wind;

FIG. 2 is a schematic illustration of flow from a premixer into a combustor, schematically showing how flow is altered by DBD actuation;

FIG. 3 is a schematic illustration of the stability range improvements provided by reducing flashback, as one application of the present invention;

FIG. 4 is a schematic illustration of a commercial burner in accordance with the prior art, in which DBDs may be positioned in accordance with the present invention;

FIG. 5 is a schematic illustration of an experimental burner used to demonstrate the present invention;

FIG. 6 is a graph showing typical current and voltage load of the DBD in the experimental burner in use;

FIGS. 7 and 8 are panels of images of flames produced with the experimental burner with and without DBD actuation;

FIGS. 9 and 10 are graphs showing velocity profiles with and without DBD actuation; and

FIG. 11 is a table showing equivalence ratio and fuel mass flow rates showing stability ranges that are extended by the selective actuation of DBDs, in accordance with the present invention.

### DESCRIPTION OF PREFERRED EMBODIMENTS

Applicant has demonstrated that a stability range of a burner can be extended with the modification to flow profile offered by a dielectric barrier discharge (DBD) (non-thermal plasma) located within a premix supply leading to a combustion chamber that has a wider flow cross-section than the premix supply. The DBD can be provided in a pair of electrodes separated by a dielectric, and both electrodes may be in a common wall of the premix supply. The electrodes may be arranged to generate the ionic wind in a direction of flow through the premix supply. If a first electrode is substantially upstream of the second electrode, the ionic wind may include a substantial component that is parallel to the wall in the direction of flow through the premix supply. As DBDs exert greater field strengths closer to the dielectric, the DBD naturally accelerates the flow more closer to a wall of the premix supply where they are embedded, and accordingly it is natural to deploy the DBDs to impart a velocity profile of the fuel and oxidizer gas that is modified to increase a velocity gradient near the wall. Regardless of how the ionic wind is specifically arranged with respect to the flow, the DBD operates to impart an acceleration to the boundary layer flow in the presence of abrupt changes in geometry, such as at the mouth of the combustion chamber.

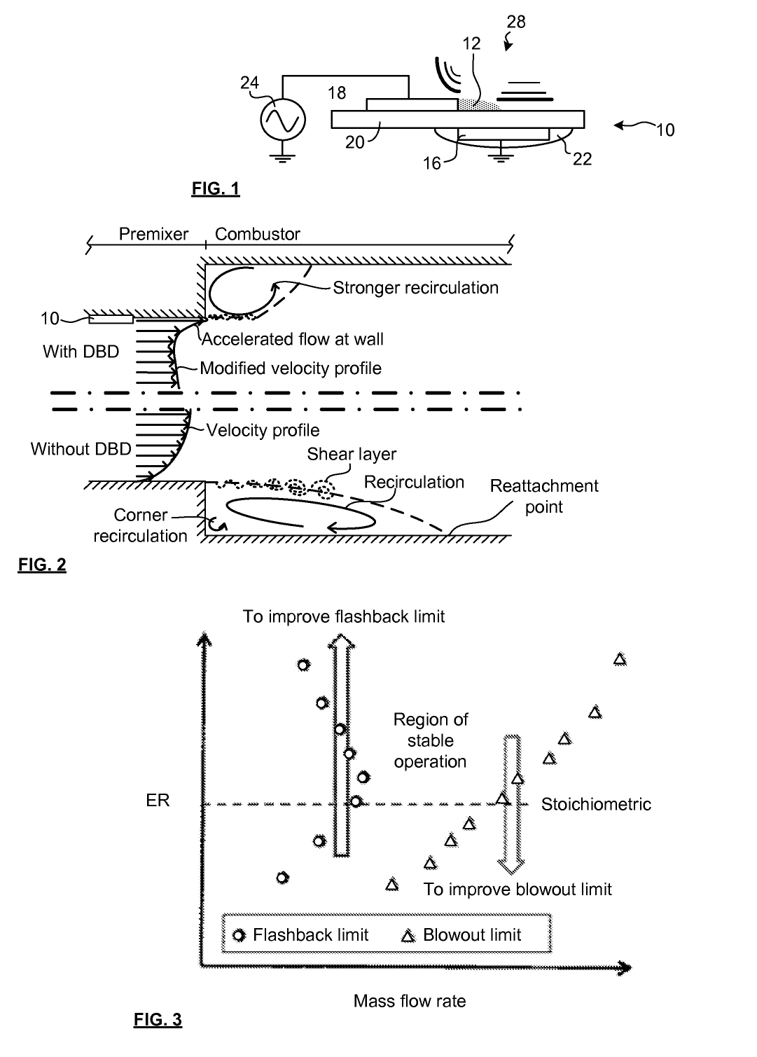

FIG. 1 is a schematic illustration of a DBD 10 that may be used in accordance with the present invention, and a plasma 12 and ionic wind 14 it tends to produce. The DBD 10 consists of two electrodes 16,18 separated by a dielectric barrier layer 20. Specifically, a buried ground electrode 16 is shown embedded in a wall 22 of a premix supply, and a high voltage electrode 18 is shown schematically coupled to a high voltage, high frequency waveform generator 24.

The use of DBDs as ionic jet inductors, is well known in the art. In use, a high-frequency AC electric signal of, typically, several kilovolts is applied to the electrodes. Gas in the vicinity of the electrodes gets partially ionized, generating a plasma 26. The electric field accelerates the charged particles, effectively rarifying the vicinity, and producing an ionic wind of a few meters per second in the principal direction of the electric field. The rarefaction naturally draws more neutral gas into the vicinity by the positive gas pressure. The ions subsequently transfer their kinetic energy to the neutral gas molecules around them via collisions, distributing the momentum throughout the gas flow. Thus the sum effect on a flow is shown schematically as a wind 28, which draws the gas into the vicinity, and ejects it substantially along the wall 22. The wind 28 is generally needed on just one side of the dielectric barrier layer 20 and therefore the electrode 16 is embedded within the wall 22 under a layer of insulation, for example. This avoids the formation of unexploited plasma and improves the efficiency of the DBD without changing the working principle [1].

It is worth noting that in generating the ionic wind, DBDs do not introduce any exogenous material into the gas flow. The DBDs redirect some part of the gas flow towards the location where plasma is [2], and accelerate the ions generally parallel to the dielectric barrier layer 20. Other investigations [3] have shown that for a fixed actuator input frequency, the equivalent body force (DBD's strength) induces flow acceleration (ionic wind) that generally increases with increasing input voltage.

Based on the knowledge in the art, it is expected that for a tubular flow and fixed mass flow rate, a DBD will accelerate the flow at the wall by directing flow away from the centerline axis towards the wall 22. This is schematically illustrated in FIG. 2, where tubular flow into a sudden expansion is shown. FIG. 2 shows a premix supply (i.e. a part of a premix chamber that is coupled to a combustion chamber for supplying the premixture of oxidizer and fuel). The bottom and the top parts of the figure depict the flow profiles without and with DBD application respectively. With DBD actuation, the velocity profile changes from a typical pipe-flow profile to one that shows an increase in flow velocity near the wall and a decrease in velocity at the centerline. This is more conveniently illustrated with an assumed laminar flow, as shown in FIG. 2, however it will be appreciated that flows feeding combustors are typically turbulent. While the laminar velocity profile is shown modified, with the highest flow rates closest to the centre of the flow without the DBD, and the highest flow rates closest to the wall with the DBD, it will be appreciated that this illustration is schematic, and the extent of the profile modification will depend on numerous parameters, including the velocity and mass flow rate of the mixture, the power supplied to the DBD, the Reynolds number of the flow, and the geometry. FIG. 2 also shows the expected influence of this change in velocity profile in the tube on the flow characteristics after the sudden expansion, i.e. within the combustion chamber. In particular, the location of the reattachment point is expected to be closer to the expansion (dump) plane [4], resulting in a stronger outer recirculation zone. As the turbulent shear layer is minimized, and separated from the bulk of the flow, it is expected that fluctuations and vortices at a periphery of the gas flow entering the combustion chamber will be minimized, and that this can improve a stability limits of a flame.

FIG. 3 schematically illustrates how the present invention provides for a broadening of the region of stable operation, specifically with reference to variation of a mass flow rate and equivalence ratio. The flashback limit precludes low mass flow rates, for a given equivalence ratio. By providing greater velocity of the flow along its periphery, the present invention reduces the initiation of flashback, even when operating with lower mass flow rates or richer fuel mixtures, which would otherwise tend to flashback. Advantageously, the DBD may be disposed on a single wall of the premix supply, and therefore preferentially affects a peripheral flow of the fuel and oxidizer gas flowing therethrough. Advantageously, the DBD may be provided near a dump plane to have a most direct effect on the flow as it approaches the flame. Advantageously the DBD may consist in an arrangement of one or more DBDs that are arrayed symmetrically about a periphery of the flow to uniformly and preferentially affect the periphery of the flow. The DBD may emit a wind that is substantially along a single wall in which both the electrodes are embedded. The ionic wind may be in a direction that follows the flow, for example to increase a flow gradient along the wall in the direction of the flow.

If the premix supply defines a pipe flow, there may be one continuous wall defining the premix supply, and each DBD may be embedded in this wall. The DBD may encircle the premix supply with a pair of conductive rings that are separated by a cylindrical dielectric layer, with one of the rings being upstream of the other so as to generate a field having electric field lines that are at least somewhat directed parallel to the surface in a direction of the flow. Substantially equivalently, there may be several DBDs arranged on the wall in a rotationally symmetric group, for example with each DBD being a same distance from the dump plane. These DBDs may be independently actuable or may be on a common bus for concurrent actuation. There may further be several rings or groups at different distances from the dump plane.

If the premix supply defines an annular flow, or has a mandrel partially inserted into it from the supply side, it may be desirable to provide one or more DBDs on the mandrel. The velocity gradient provided by flows in the neighbourhood of walls, as shown in FIG. 2 with the pipe flow example, leads to a relatively wide variety of velocities within the laminar flow.

It has been observed that flashback is known to preferentially occur along walls. So increasing a gradient by directing ionic wind in a direction of the flow along the walls is likely to reduce this kind of flashback. Similarly, one or more DBDs may be disposed on a mandrel or inner wall of the premix supply to direct ionic wind to additionally preclude flashback along a boundary layer of the mandrel. Alternatively there may be DBD groups/rings on both outer and inner walls of the premix supply. The mandrel actuation may be have different frequency, amplitude and/or phase depending than that of the outer wall, to optimize desired flow conditions.

It may further prove useful to direct flow in an azimuthal direction, by orienting one or more DBDs to emit ionic wind azimuthally, or by actuating the aforementioned group of symmetrically arrayed DBDs for actuation at different times as a function of azimuth. For example, the azimuthal flow may improve mixing of the mixture, or flame anchoring. By using a plurality of DBDs in the premix supply for flow control, a variety of actuation regimes may be defined to impede flashback along a plurality of flashback paths.

It will be noted that the previous reacting-flow studies used DBDs to enhance of chemical kinetics to improve flame lean blowout limits. The effect may additionally be provided to some degree using the present invention, however the prior art DBD arrangements did not favourably use the fluid dynamic effects of DBDs.

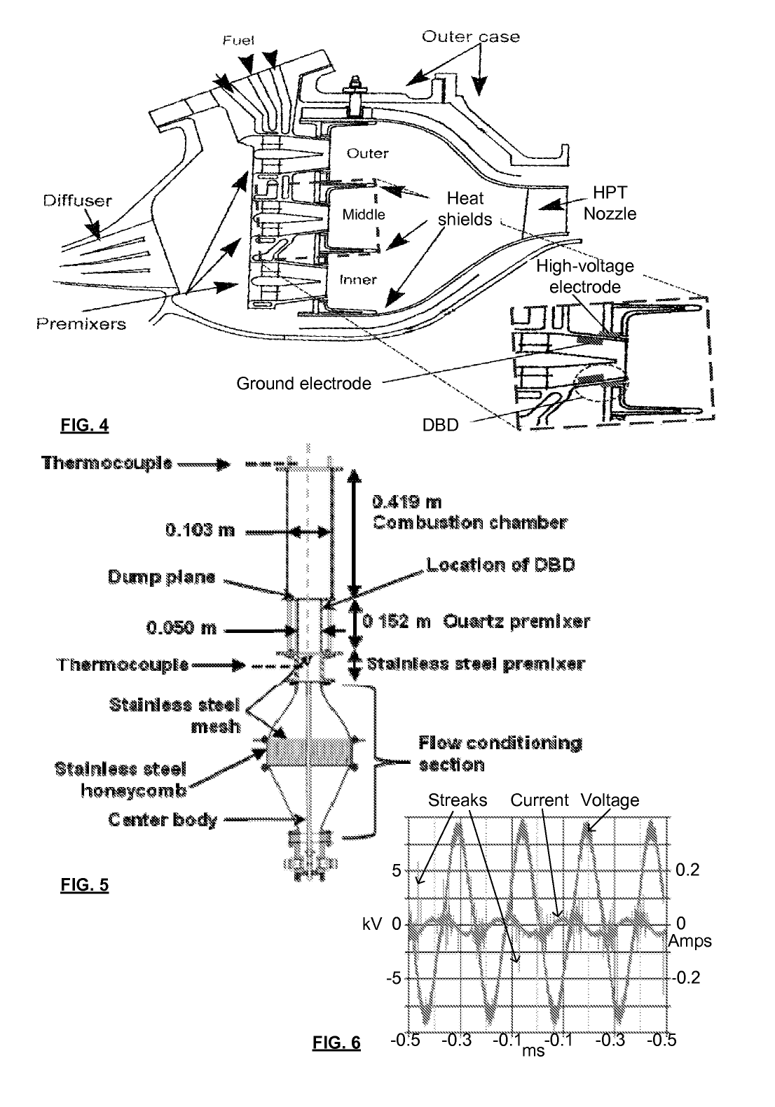

FIG. 4 is a schematic illustration of a commercially available burner having a plurality of combustor manifolds with independent fuel supplies, and a diffuser supplying an oxidizer. As an illustration of how the DBDs may be deployed in a premix supply of a combustor, the enlarged section shows one possible arrangement. It will be appreciated that implementation in a wide variety of burners is possible.

### EXAMPLES

The following examples demonstrate the reduction of the flashback limit provided with actuation of DBDs in the premix supply, on one wall of the premix supply, with one electrode upstream of the other, for which a resulting ionic wind is substantially in the direction of flow (even with the DBD not actuated).

FIG. 5 is a schematic illustration of an atmospheric combustion rig used in present demonstrations. A gaseous combustible mixture enters the vertical rig through four inlets, equally spaced circumferentially at the bottom of the rig. The flow then passes through a settling/flow-conditioning section comprising a diffuser, a stainless steel honeycomb, a fine-meshed screen and a contraction, before entering the premixer. The premixer includes a first part made from stainless steel, which provides instrumentation ports and acts as an interface between the contraction section and the second part of the premixer. The second part of the premixer is made out of quartz (a good dielectric) to facilitate the integration of DBD. The two parts of the premixer are separated by a fine stainless steel wire mesh, which is installed as a security precaution, to prevent the flame from travelling upstream, into the contraction section. The wire mesh was grounded through the metal section of the premixer as part of the DBD setup. The premixer has an inner diameter of 0.050 m and a length of 0.152 m.

The flow exiting the premixer enters a quartz combustion chamber that is 0.419 m long and has an inner diameter of 0.103 m. Two type-K thermocouples are installed, one in the stainless steel premixer section and the other at the combustor exit to measure the temperatures of the combustible mixture and the exhaust gases, respectively.

The rig is also provided with a tubular central lance (i.e. center body) through which fuel or fuel-air mixture may be introduced for diffusion and partially-premixed flame studies. For the present work, the centre body was not used and thus the lance was pulled upstream to sit in line with the exit of the contraction section, as shown in FIG. 4.

The gas supply system used for the studies had five feed lines: one for compressed air, and the other four for fuels and inert gases. The gases were fed to a static mixer where various fuel compositions and air were mixed uniformly online, before the introduction of the combustible mixture to the combustion rig. The fuel lines were provided with solenoid valves and check valves for safety. The only fuel used for the present study was natural gas, supplied by a commercial fuel line. Typical composition of the fuel is: Methane: 96.49 vol. %; Ethane: 1.41 vol. %; Nitrogen: 1.31 vol. %; Carbon dioxide: 0.68 vol. %; Propane: 0.09 vol. %; Normal-Butane: 0.01 vol. %; and Iso-Butane 0.01 vol. %.

The air flow rate was metered via an electronic flow controller. Fuel supply was controlled using manual needle valve but monitored using an electronic flow meter. The controller and the flow meter were calibrated for the correct range of supply with full scale accuracy of ±1%.

Digital images and videos of the flame were captured using a 12.3 megapixel Nikon D300 camera with a shutter speed of 1/8000s-30s and repetition rate of 8 frames per second. Two different camera lenses were used: a 50 mm and an 85 mm lens. The camera was mounted with its image plane parallel to the combustion chamber's centerline axis.

A Constant Temperature Anemometer (CTA) from Dantec Dynamics was used to characterize the flow velocity profiles, with and without DBD application. The measurements were made under non-reacting iso-thermal conditions, approximately 1 mm downstream of the combustor dump plane along two orthogonal axes. The mass flow rate of air through the combustor during these measurements was set to match the average flow velocity under combustion experiments. For each measured point, 10,000 samples were recorded at a rate of 3 kHz. To avoid electromagnetic interference from the DBD actuator (operated at 4 kHz) on the velocity measurements, a low-pass filter of the CTA system was set at 3 kHz. For these measurements, the combustion chamber length was shortened to allow the introduction of the CTA probe.

A photograph of the rig setup is given in FIG. 5, which shows the location of DBD actuator with respect to the combustor inlet (dump plane). For the purpose of the experiments the DBD was installed on the 2.5 mm thick wall of the quartz premixer. A thin stainless steel sleeve was inserted concentric to the inner diameter of the quartz premixer and attached to the grounded stainless steel mesh (which primarily served as a flame arrestor). The stainless steel sleeve thus served as the ground electrode for the DBD actuator setup. The length of the sleeve was adjusted to end 0.044 m short of the combustor dump plane. This length was chosen to improve the influence of ionic wind from actuated DBD on the flow/flame dynamics and to prevent electric arcing with the stainless steel dump plane. A copper foil tape 0.013 m wide, and 0.074 mm thick (0.038 mm of adhesive and 0.036 mm of metal) was placed on the outer wall of the premixer and covered with insulation. The copper foil, which served as the encapsulated electrode, was connected to a high-voltage generator from Electrofluids Systems (Minipuls 6). When supplied with the required voltage, this DBD actuator configuration provided its ionic wind in the downstream flow direction.

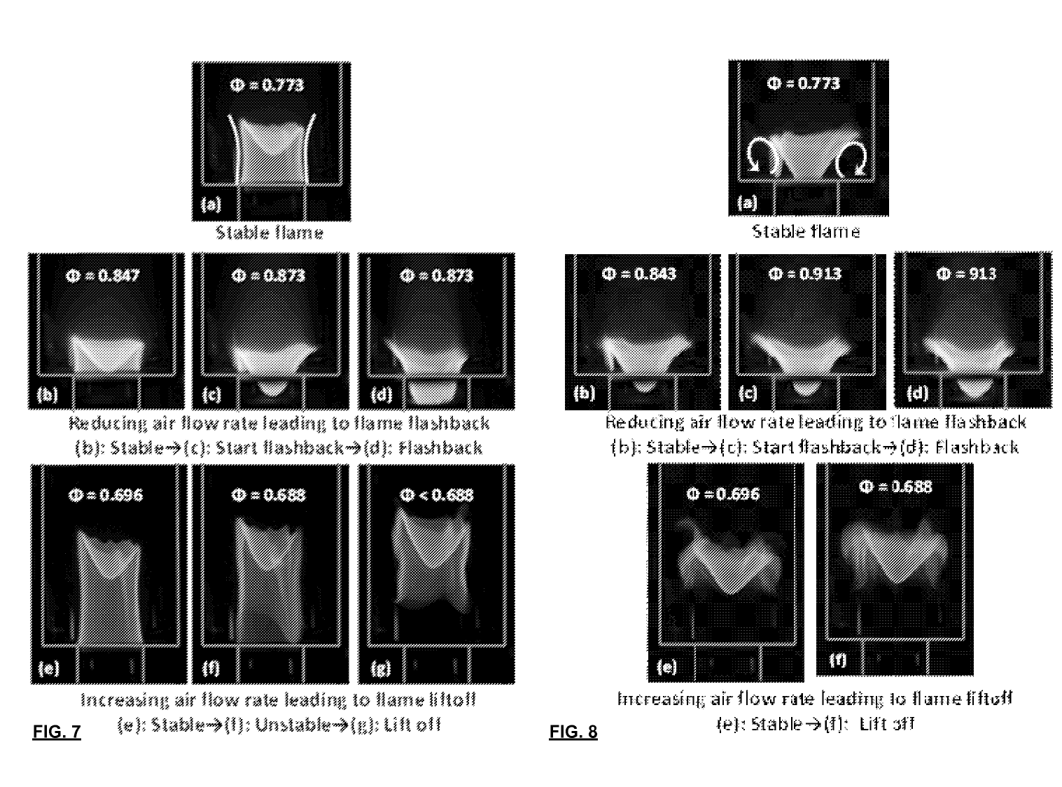

A typical AC signal generated by the high-voltage (HV) generator and applied across the electrodes for all the experiments reported here, unless otherwise explicitly stated, is shown in FIG. 6. It consists of a 4 kHz triangular wave, with a peak-to-peak voltage of 19.2 kV. The signal was continuously monitored via a probe mounted on the HV generator and connected to an oscilloscope.

FIG. 6 also shows the time resolved current consumption of the system measured with a PEARSON model 4100 current monitor, also connected to the oscilloscope. The current curve shows streaks during the rise and fall of the voltage in the cycle. These streaks indicate the generation of plasma and thus plasma was only generated for a fraction of the cycle. Since the period of the AC signal is generally much smaller that the response time of the flow, it is common to consider the plasma generation and the associated induced (ionic wind) velocity as a continuous process.

From the typical voltage and current signatures shown in FIG. 6, one may calculate the total power consumption for DBD to be 156.6 W, which corresponds to only 2.4˜4.4% of the thermal power of the combustion system. However, it may be noted that all of this electrical power is not consumed by the DBD actuator because of the losses in the system [15].

During the experiments, the combustor was ignited at a given fuel flow rate using a spark igniter and the flame was stabilized at the dump plane by adjusting the air flow rate. Thereafter, the fuel flow rate was held constant while the air flow rate was metered via the DAQ system in predetermined steps toward either the rich (flashback) or lean (blowout) conditions. For every measurement point, the flame was first stabilized at the dump plane for two minutes to allow for the combustion chamber and the premixer to achieve thermal equilibrium. For the flashback points, seven flashbacks were induced. The measured fuel and air flow rates for the last five were averaged and used to produce the data, while the first two flashbacks were not considered and were aimed mainly at heating up the premixer. To ensure repeatability of the data, the experiments were conducted at an almost constant pace such that the time between every flashback occurrence was nearly constant (˜4 minutes). Hence, around 30 minutes of burning were necessary to record a single data point. A similar procedure was adopted to produce other data points corresponding to flame liftoff and blowout.

Controlled flashback occurrences were generated by metering the air flow rate at a fixed fuel flow rate. It was found that in the experimental combustor the flashback happens through the core flow when DBD actuation is applied. Thus the flashback along the periphery of the flow was effectively prevented using the particular DBD arrangement used.

To further verify the repeatability of the results, the flame flashback and liftoff limits at a fixed fuel flow rate of 0.102 g/s, with and without DBD actuation, were measured twice on two consecutive days. The variations were found to be less than 0.65%, thus giving confidence in the data accuracy. In addition, standard deviation for all data points was also calculated. The maximum uncertainty of the fuel flow rate normalized by its corresponding mean value was found to be 0.23%, while the uncertainty in equivalence ratio at flashback, liftoff and blowout conditions were found to be 0.27%, 0.18% and 0.51% respectively.

FIGS. 7 and 8 show images of the flame, without and with the application of DBD, respectively. For the frames (a) to (d) of each figure, the 85 mm lens was used, while the 50 mm lens was used for the rest. These images were recorded at a fuel flow rate of 0.102 g/s and various air flow rates i.e., various equivalence ratios. On each image, the bold lines represent the position of the dump plane and the walls of the premixer and combustor sections. It was found that the application of DBD actuation had a pronounced effect on the flame, including the flame anchoring mechanism in the combustor, and flashback and liftoff limits.

FIGS. 7 and 8, image (a), represent stable flames at the same fuel and air flow rate conditions. A comparison between these images shows that the flame stabilization mechanisms encountered without and with DBD application are quite different. Without DBD actuation, the flame stabilizes on the rim of the premixer, whereas with DBD actuation i.e., under the influence of the ionic wind generated by the DBD, the flame anchoring is provided by the outer recirculation zones. This behavior is supported by the observations available in the literature [4]. The acceleration of flow in the vicinity of the wall of the premix supply, by the application of DBD, helps in strengthening the outer recirculation zone in the combustor, which in turn helps in anchoring the flame at the dump plane.

Comparison between the images of FIGS. 7 and 8 further shows that the application of DBD modifies the flame characteristics at any given operating condition. This is true both for increase in equivalence ratio (leading to flame flashback) as well as for decrease in equivalence ratio (leading to flame liftoff and blowout). Also, when comparing FIG. 7 with FIG. 8, it may be noted that at an equivalence ratio of 0.696 (Image (e) on both figures), the flame is attached to the dump plane for the case without actuation, while it is lifted-off for the actuated case. Hence, the flame detaches at lower air mass flow rate with the DBD actuation. Controlling actuation rates may therefore be useful in extending a range of stable flame conditions.

Concerning the flashback process, FIG. 7, images (b) through (d), show that for the non-actuated case, as the equivalence ratio is increased through reduction in air mass flow rate, the stabilization location of the flame front gradually moves upstream along the axis of the combustor until it fully detaches from the rim. Immediately thereafter the flame starts to propagate into the premixer. However, for the actuated case of FIG. 8, it will be noted that although the flame protrudes upstream of the dump plane with the increase in equivalence ratio, it stays stabilized until a much higher equivalence ratio. Thereafter the flame flashes back in the premixer.

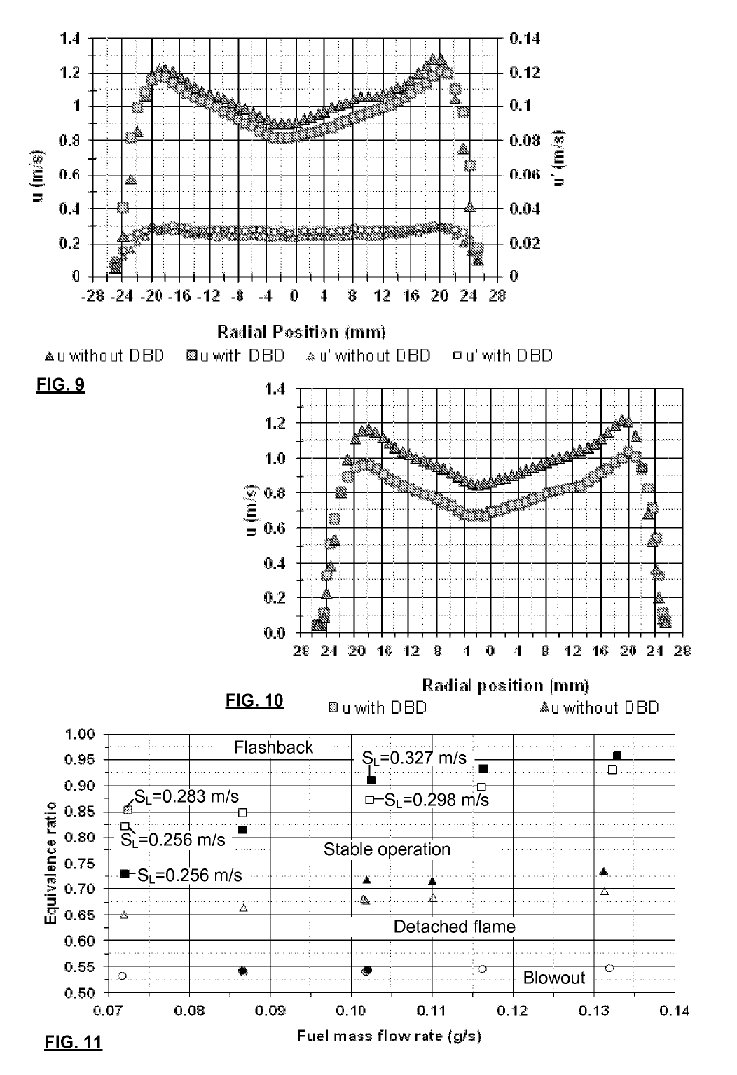

In order to verify that the observed differences in the flame characteristics were indeed due to the modification of flow field caused by the actuation of DBD, flow velocity measurements were made using the CTA. These measurements were conducted at 1-mm downstream of the dump plane and across the combustor cross section under non-reacting flow conditions at various flow rates. Sample results are shown in FIG. 9, where the operating conditions correspond to those of stable flames of FIGS. 7 and 8. The mean velocity profiles show a dip at the centerline axis of the combustor. This is expected for flows exiting a contraction section and not having enough length to adopt a fully developed tubular flow, which was the scenario in the current work, and is expected in combustion chambers. FIG. 9 also shows that the velocity gradient in the near wall region increases with the application of DBD. Because the mass flow rates are held constant, the increase in velocity closer to the wall is substantially compensated by the decrease in velocity magnitude at the axis. The net increase in velocity caused by the acceleration of the ionic wind is marginal.

FIG. 10 shows mean velocity profiles for operating condition where average flow velocity was matched to that at flashback condition (FIGS. 7,8 Image (c)). Because the equivalence ratio under the DBD case is significantly higher compared to that of non-actuated DBD case, the total flow rate for the DBD case is thus lower. Nevertheless, comparison of velocity profiles shows that one of the effects of DBD actuation is to increase the velocity gradient at the wall. For the conditions of FIG. 10, this increase is from 250 s⁻¹ (as measured from without-DBD profile) to 346 s⁻¹. The increase in velocity gradient shown in both FIGS. 9 and 10 explains flame liftoff with DBD actuation (for example, compare Image (e) of FIG. 7 with Image (e) of FIG. 8, recorded under the same flow rate and equivalence ratio).

The combustor performance as encountered during the present work is mapped on the stability diagram of FIG. 11. The flashback, liftoff and blowout limits separate combustor operation into four different zones. The mapping was conducted by keeping the fuel mass flow rate constant and varying the air flow rate in discrete steps either towards flame flashback or towards flame liftoff and subsequent blowout. From the flashback point of view, decrease in air mass flow rate translates into lower flow velocities as well as higher equivalence ratios, which in lean conditions leads to higher flame speeds [11]. Hence, in the present work, reduction of air flow rate promotes flame flashback in two different ways. This behaviour corresponds to the upper region of the stability diagram. On the other hand, as the air flow rate is increased, the flow velocity rises, the equivalence reduces and so does the flame speed. At sufficiently high air flow rate, the flame starts to liftoff and the combustor operation is characterized by an unstable and lifted flame. This point corresponds to the liftoff limit defined by the triangles on the stability diagram. Ultimately, the flame is completely lifted off and this behaviour is observed for operating conditions in the detached flame region of the stability diagram. When the air flow rate is increased further, the flame is pushed out of the combustion chamber. This condition is indicated by the blowout points (circles) on the stability diagram of FIG. 11.

As shown in FIG. 11, stability limits were extended by the DBD actuation for the three higher fuel flow rates. In terms of equivalence ratio, a maximum improvement of 4.6% was achieved at a fuel flow rate around 0.102 g/s and with a 19.2 kV peak-to-peak voltage at 4 kHz frequency applied to the DBD actuator. The fact that the equivalence ratio at which flashback occurs increases with the application of DBD, does not only mean that it takes place at a lower air flow rate (lower by 4.2% at this fuel flow rate), it also signifies that flashback happens at a much higher flame speed. Flame speeds (S_{L}) calculated using data from [12] for methane are shown in FIG. 11 for some selected flashback points. For the operating point where maximum control is achieved through DBD use, the flashback occurs at a flame speed 9.8% higher compared to a flame speed of 0.298 m/s under no actuation case. This implies that if the experiments were to be conducted at fixed equivalence ratio (thus at fixed flame speed) by varying the air and fuel flow rates simultaneously (as is commonly performed in commercial burners), the improvement in flashback control via DBD application would have been even higher.

For the two lower fuel flow rates of FIG. 11 it may be noted that the application of DBD at a voltage of 19.2 kV, favours the occurrence of flashback, thus causing a shrinkage in the stable operation regime. This is due to the reduction of the axial velocity in the core flow that occurs to compensate the velocity rise near the wall when the DBD is turned on. At an already reduced air flow rate this additional velocity reduction at the axis supports flashback initiated at the core under these flow conditions. Therefore non-actuation of the DBD may be an important aspect for maximizing stability conditions within a burner.

Specifically, Applicant has found that it is possible to improve the flashback not only back to the non-actuated limits but even beyond, by tuning the strength of the induced ionic wind through the adjustment of the voltage applied to the DBD actuator. As shown in FIG. 11, reducing the excitation voltage from 19.2 kVₚ₋ₚ to 13.2 kVₚ₋ₚ, increased the equivalence ratio at which flashback occurs by 3.9%.

It will also be noted in FIG. 11 that DBD actuation causes flame liftoff at a much higher equivalence ratio as compared to no actuation cases as shown for the three higher fuel flow rate conditions. As pointed out earlier, this is due to the rise in the velocity gradient at the wall induced by the DBD. However, it was found that DBD actuation does not affect the blowout limit, which is a surprising result.

To further verify that DBD actuation was indeed preventing flashback, a flame was stabilized at a given fuel flow rate and the DBD actuator was turned on. The air flow rate was then reduced to attain an equivalence ratio mid-way between the actuated and non-actuated flashback limits on the stability diagram of FIG. 11. In the absence of DBD actuation, the flame immediately started to propagate upstream in the premixer. The process was repeated a few times and the same result was obtained every time.

In conclusion, a premix supply having a DBD for flow control was demonstrated. Operation of the DBD improved stability limits of a flame in the adjacent combustion chamber as was successfully demonstrated over a range of operating conditions in a premixed atmospheric dump combustor.

### REFERENCES

The contents of the entirety of each of which are incorporated by this reference:
[1] Laurentie, J.-C., Jolibois, J. and Moreau, E., 2009, “Surface dielectric barrier discharge: Effect of encapsulation of the grounded electrode on the electromechanical characteristics of the plasma actuator”, Journal of Electrostatics, 67, pp. 93-98.
[2] Jacob, J., Rivir, R., Carter, C., and Estevadeordal, J., 2004, “Boundary Layer Flow Control Using AC Discharge Plasma Actuators”, AIAA 2004-2128, AIAA 2nd Flow Control Meeting, Portland, Oreg.
[3] Thomas, F. O., Corke, T. C., Iqbal, M., Kozlov, A., and Schatzman, D., 2009, “Optimization of Dielectric Barrier Discharge Plasma Actuators for Active Aerodynamic Flow Control”, AIAA Journal, 47(9), pp. 2169-2178.
[4] De Zilwaa, S. R. N., Khezzarb, L. and Whitelaw, J. H., 2000, “Flows through plane sudden-expansions”, Internation Journal for Numerical Methods in Fluids, 32, pp. 313-329.
[5] Roth, J. R. and Dai, X., 2006, “Optimization of the Aerodynamic Plasma Actuator as a Electrohydrodynamic (EHD) Electrical Device”, 44th AIAA Aerospace Sciences Meeting and Exhibit, Reno, Nev., pp. 1-28.
[6] Versailles, P., Ghosh, S., Vo, H. D., and Masson, C., 2010, “Preliminary Assessment of Wind Turbine Blade Lift Control via Plasma Actuation”, Submitted for publication in Wind Engineering.
[7] Mureithi, N. W., Rodriguez, M., Versailles, P., Pham, A., and Vo, H. D., 2008, “A POD based analysis of the 2D cylinder wake mode interactions”, 9th Internal Conference on FIV, Prague, Czech Republic, pp. 1-6.
[8] Grundmann, S. and Tropea, C., 2007, “Experimental transition delay using glow-discharge plasma actuators”, Experiments in Fluids, 42(4), pp. 653-657.
[9] Vincent-Randonnier, A et al., April 2007, “Experimental Study of a Methane Diffusion Flame Under Dielectric Barrier Discharge Assistance” IEEE TRANSACTIONS ON PLASMA SCIENCE, 35(2) pp. 223-232.
[10] Rosocha, L. A., Coates, D. M., Platts, D., and Stange, S., 2004, “Plasma-enhanced combustion of propane using a silent discharge”, Physics of Plasma, 11, 7 pages.
[11] Cha, M. S., Lee, S. M., Kim, K. T., and Chung, S. H., 2005, “Soot suppression by nonthermal plasma in coflow jet diffusion flames using a dielectric barrier discharge”, Combustion and Flame, 141, pp. 438-447.
[12] Vagelopoulos, C. M. and Egolfopoulos, F. N., 1998, “Direct Experimental Determination of Laminar Flame Speeds”, Twenty-Seventh Symposium (International) on Combustion, 27(1), pp. 513-519.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A premix supply for supplying a fuel and oxidizer gas into a combustion chamber for burning, the premix supply having a smaller diameter flow than the combustion chamber, the premix supply comprising at least one dielectric barrier discharge device (DBD) comprising two electrodes separated by a dielectric, wherein both electrodes are provided in a single wall of the premix supply.

2. The premix supply of claim 1 wherein the at least one DBD is disposed symmetrically around the premix supply.

3. The premix supply of claim 1 wherein the at least one DBD is disposed on the premix supply adjacent a dump plane defined by the interface of the premix supply and the combustion chamber.

4. The premix supply of claim 1 wherein the electrodes are arranged to accelerate the fuel and oxidizer gas in a direction along the wall.

5. The premix supply of claim 1 wherein one of the two electrodes is partially upstream of the other of the two electrodes.

6. The premix supply of claim 1 wherein the electrodes are arranged to accelerate the fuel and oxidizer gas in a direction of the flow, with greater acceleration occurring closer to the wall of the premix supply, whereby a pipe-flow velocity profile of the fuel and oxidizer gas is modified to increase a velocity gradient the wall.

7. The premix supply of claim 1 wherein each of the at least one DBD is in a same wall, the wall defining an outer diameter of a flow of the fuel and oxidizer gas.

8. The premix supply of claim 1 assembled in a burner for fluid communication with a combustion chamber.

9. A premix supply for supplying a fuel and oxidizer gas into a combustion chamber for burning, the premix supply having a smaller diameter flow than the combustion chamber, the premix supply comprising at least one dielectric barrier discharge device comprising two electrodes separated by a dielectric, wherein the electrodes are arranged to generate an ionic wind preferentially in a same direction as a flow through the premix supply.

10. The premix supply of claim 9 wherein the at least one DBD is disposed symmetrically around the premix supply.

11. The premix supply of claim 9 wherein the at least one DBD is disposed on the premix supply adjacent a dump plane defined by the interface of the premix supply and the combustion chamber.

12. The premix supply of claim 9 wherein the electrodes are both disposed in a same wall of the premix supply.

13. The premix supply of claim 9 wherein one of the two electrodes is partially upstream of the other.

14. The premix supply of claim 9 wherein the electrodes are arranged to accelerate the fuel and oxidizer gas, with greater acceleration occurring closer to the wall of the premix supply, whereby a velocity profile of the fuel and oxidizer gas is modified to increase a velocity gradient at the wall.

15. The premix supply of claim 9 wherein each of the at least one DBD is in a same wall, the wall defining an outer diameter of a flow of the fuel and oxidizer gas.

16. The premix supply of claim 9 assembled in a burner for fluid communication with a combustion chamber.

17. A method for reducing flashback within a burner having a premix supply in fluid communication with a combustion chamber, the premix supply having a smaller diameter flow than the combustion chamber, comprising:
providing in a wall of the premix supply at least one dielectric barrier discharge device having two electrodes separated by a dielectric; and
applying current to the dielectric barrier discharge device to generate an ionic wind preferentially in a same direction as a flow through the premix supply, at least when there is an elevated risk of flashback along the wall.
